(19) United States
(12) Patent Application Publication
(10) Pub. No.: US 2002/0162884 A1
(43) Pub. Date: Nov. 7, 2002

(54) Low-power smart-card module

(76) Inventors: Gary W. Speas, Little Rock, AR (US); Seth Ward II, Little Rock, AR (US)

Correspondence Address: J. Robert Brown, Jr., HUNTON & WILLIAMS, Energy Plaza, 30th Floor, 1601 Bryan Street, Dallas, TX, 75201-3402, US

(21) Appl. No.: 10/141,291

(22) Filed: May 7, 2002

Related U.S. Application Data
(60) Provisional application No. 60/289,208, filed on May 7, 2001.
(60) Provisional application No. 60/352,431, filed on Jan. 24, 2002.

(51) Int. Cl. G06K 5/00

(52) U.S. Cl. 235/380

(57) ABSTRACT

A low-power smart card reader that plugs into the circuit board of a base-model electronic meter is provided. The smart card reader includes positive contacts for reading the card chip and a circuit board to step-up the voltage, pass through the commands, and provide a CPU clock. The smart card reader circuit board includes sockets for its own plug-in microprocessor and multiple SAM modules. A development system couplable to a computer system for developing security schemes such that vending machines can accept smart cards is provided. The development system further includes a reader and at least one socket operable to receive a security access module. The reader is operative to read smart cards. At least one socket is in communication with a processor operative to determine which of the sockets includes the security access module adapted to communicate with the security scheme of the card read by the reader.

### CROSS-REFERENCE TO RELATED APPLICATIONS

Pursuant to 35 U.S.C. § 119(e), this application claims the benefit of U.S. Provisional Patent Application Ser. No. 60/289,208, entitled Parking Meters with Separate Low-Power Smart-Card Module, filed May 7, 2001, naming Seth Ward, II, as inventor, and U.S. Provisional Patent Application Ser. No. 60/352,431, entitled Card Reader having Multiple Security Access Module Sockets and On-board Microprocessor, filed Jan. 24, 2002, naming Gary W. Speas and Seth Ward, II, as inventors, both of which are hereby incorporated by reference for all purposes.

### TECHNICAL FIELD OF THE INVENTION

This invention relates in general to the field of card readers and security access modules and more particularly, but not by way of limitation, to a card reader having multiple security access module sockets and on-board microprocessor.

### BACKGROUND OF THE INVENTION

Many problems exist with modern vending machines and parking meters. Individuals utilizing the machines may not have the proper change, the machines are subject to vandalism and mechanical failures, and it is time-consuming and costly to collect money from the machines. Recently, vending machines began accepting credit and smart cards to overcome these disadvantages. The broad range and rapid development of various credit and smart cards, however, presents additional problems for manufactures of vending machines.

The vending machines and parking meters become outdated or obsolete by continual introduction of new generation credit and smart cards. Also, security systems for managing the operation of vending machines and the credit or smart card driven financial transactions must be more robust in this modern era of high technology.

Financial and other institutions utilize proprietary technology including encrypted instructions for managing the financial transactions associated with their credit and smart cards. The vending machine manufacturer is required to integrate these proprietary systems, known as security access modules, into the vending machines to enable the vending machine to accept the credit and smart cards.

For this reason, a need exists for an improved card reader having security access modules for use by vending machines.

### SUMMARY OF THE INVENTION

It should be appreciated that financial institutions and providers of credit and smart cards, both of which are hereinafter referred to as smart cards, do not want to disclose their proprietary security schemes. Security schemes or security access modules (SAMs), particularly those for accepting smart cards, are frequently utilized by vending machines, such as parking meters and other unmanned devices where individuals may purchase products and services. The manufacturers of vending machines also want to protect and keep confidential the security systems that operate the vending machine.

To develop SAMs for use by vending machines requires that the vending machine, including the proprietary security system operating the vending machine, be made available to the financial institution. In addition, bulky and unnecessary components of the vending machine are delivered to the developers of financial institution smart card for these purposes.

The developers of the financial institution's security access module use the vending machine to develop and test their smarts cards to ensure compatibility with the vending machine. Once developed, the security access modules are then integrated, frequently unitarily, with the vending machine. Such integration with the vending machine makes upgrades to different or modified smart card systems costly and inefficient.

For this reason, the present invention provides a development system couplable to a computer system for developing security schemes whereby vending machines can utilize smart cards. The development system includes a coupling connectable to the computer system for communication with the computer system. The development system further includes a reader, at least one security access module and at least one socket. The reader is in communication with the computer system via the coupling and operative to read credit and smart cards in a contacting or contact-less manner, the cards include a security scheme.

The at least one security access module has a processor. The security access module is adapted to communicate with the security scheme of the cards. The at least one socket in communication with the reader. As such, when the reader reads the cards, the processor is operative to determine which of the at least one socket includes the security access module adapted to communicate with the security scheme of the card read by the reader.

In one aspect, the development system further includes a processor in communication with the reader. In yet another aspect, the development system is coupleable to a vending machine in a modular fashion. In yet another aspect, the development system is coupleable to a parking meter via the coupling.

The use of electronics in parking meters and other vending devices has brought up new, sometimes conflicting problems. Electronic “smart” cards allow a user to use a prepaid card instead of cash for small purchases such as parking fees, but the need for a manufacturer to provide this capability is constrained by the need to keep power usage low on these isolated points of service.

In another aspect, the present invention provides a development system couplable to a computer system for developing compatible security schemes whereby vending machines can utilize smart cards. The development system includes a coupling, a reader and at least one socket. The coupling connectable to the computer system for communication with the computer system. The reader is operative to read smart cards in a contacting or contact-less manner, the cards include a security scheme.

The at least one socket is operable to receive a security access module having a processor adapted to communicate with the security scheme of the cards. The at least one socket is in communication with the processor such that when security access module is received by the socket and the reader reads the cards, the processor is operative to determine which of the at least one sockets includes the security access module adapted to communicate with the security scheme of the card read by the reader.

In one aspect, the development system further includes a processor in communication with the reader and the at least one security access module. The development system further includes a development tool operable for producing security access modules compatible with a vending machine. The development system further includes an emulator operable to emulate the vending machine for testing the security access module for compatibility purposes.

One advantage of the present invention is that the development system may be utilized by the developers of the financial institution's security scheme and security access modules without the necessity of providing the entire vending machine. Another advantage of the present invention is that the security system employed by the vending machine is not compromised since the vending machine's security system is not accessible to the developers of the security access module.

In another aspect, the present invention is directed to a smart card reader assembly couplable to a vending machine for allowing smart card vending transactions. The smart card reader assembly includes a coupling, a reader and at least one socket. The coupling connectable to the vending machine for communication with the vending machine. The reader operative to read smart cards in a contacting or contact-less manner, the cards include a security scheme.

The at least one socket is operable to receive a security access module having a processor adapted to communicate with the security scheme of the cards. The at least one socket is in communication with the processor such that when security access module is received by the socket and the reader reads the cards, the processor is operative to determine which of the at least one sockets includes the security access module adapted to communicate with the security scheme of the card read by the reader.

In one aspect, the present invention is directed to a vending machine allowing credit and smart card transactions. The vending machine includes a vending portion, a main module and a card reader assembly. The vending portion is operable to vend good and services. The main module includes a processor. The main module operably communicates with the vending portion.

The card reader assembly connectable to the main module in a communicating relationship. The card reader assembly including a reader operative to read smart cards in a contacting or contact-less manner, the cards including a security scheme. The card reader assembly including a processor and at least one socket. The processor in communication with the reader

The at least one socket is operable to receive a security access module adapted to communicate with the security scheme of the cards. The at least one socket is in communication with the processor such that when the security access module is received by the socket and the reader reads the cards, the processor is operative to determine which of the at least one sockets includes the security access module adapted to communicate with the security scheme of the card read by the reader.

In yet another aspect, the present invention is directed to an electronic parking meter allowing cash and smart card transactions. The electronic parking meter including an assembly and a main module. the assembly including a display to display information relative to parking services. The main module includes a processor. The main module is in communication with the display.

The electronic parking meter further including a card reader assembly connectable to the main module in a communicating relationship. The card reader assembly including a reader, a processor and at least one socket. The reader is operative to read smart cards in a contacting or contact-less manner, the cards including a security scheme. The processor is in communication with the reader. The at least one socket is operable to receive a security access module adapted to communicate with the security scheme of the cards. The at least one socket is in communication with the processor such that when the security access module is received by the socket and the reader reads the cards, the processor is operative to determine which of the at least one sockets includes the security access module adapted to communicate with the security scheme of the card read by the reader.

Another advantage is that the present invention simplifies the development of security access modules by making the development system available to developers. Another advantage is the card reader assembly, including the security access modules is modularly connectable to the vending machine, making upgrades or changes to the financial transaction portion of the vending machines simple and cost effective.

According to one aspect, the present invention provides a parking meter having a data interface element, which provides bi-directional data interface with portable purchasing modules; a display; and a programmable logic module connected to control said data interface element and said display, but not integrated with said data interface element; wherein said programmable logic module is also connected to control whether said data interface element is powered up or not. It is noted that for the purposes of this application, the term portable purchasing modules include smart cards, but this term is not limited to the current generation of smart cards. Rather, it is intended to convey that it is any means that are developed to allow a consumer to pay for purchases using an easily carried item.

According to another aspect, the present invention provides a parking meter having a data interface element, which provides bi-directional data interface with portable purchasing modules; a display; and a programmable logic module connected to control said data interface element and said display, but not integrated with said data interface element; wherein said programmable logic module and said data interface element are connected to operate at different power supply voltages.

According to yet another aspect, the present invention provides a parking meter having a coin input device; a first microprocessor which is operatively connected to detect inputs from said coin input; random-access memory which is connected to be read/write accessible by said first microprocessor; an output device operatively connected to receive outputs from said first microprocessor; a power supply connected to provide power to said first microprocessor; and a second user input device and a second microprocessor which is operatively connected to detect inputs from said second user input device; wherein said first user input device and said first microprocessor are on a first card and said second user input device and said second microprocessor are on a second card which is different from said first card, and said second microprocessor is at least partially controlled by said first microprocessor.

Other objects, features, and advantages of the present invention will be apparent to those skilled in the art from the following detailed description when read in conjunction with the accompanying drawings and appended claims.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is a block diagram of a card reader assembly constructed in accordance with the present invention;

FIG. 2 is a block diagram of another aspect of the card reader assembly constructed in accordance with the present invention;

FIG. 3 is a block diagram of a main vending module shown in communication with the card reader assembly of the present invention;

FIG. 4 is a diagrammatic illustration a development system including the card reader assembly according to another aspect of the present invention;

FIG. 5 is a block diagram of a vending machine shown coupled with the card reader assembly according to yet another aspect of the present invention;

FIG. 6 is a flow chart illustrating the card reader assembly communication according to one aspect of the present invention;

FIG. 7 is a flow chart illustrating one aspect of a development platform according to yet another aspect of the present invention;

FIG. 8 is a perspective view of an electronic parking meter that accepts both coins and smart card input according one aspect of the present invention;

FIG. 9 is a block diagram of a parking meter illustrating the card reader integrated with the parking meter circuitry; and

FIG. 10 shows a block diagram according to another aspect of the parking meter illustrating a modular board including a card reader, power supply and separate processor that may be connected to the parking meter circuitry.

### DETAILED DESCRIPTION OF THE INVENTION

It should be understood at the outset that although an exemplary implementation of the present invention is illustrated below, the present invention may be implemented using any number of techniques, whether currently known or in existence. The present invention should in no way be limited to the exemplary implementations, drawings, and techniques illustrated below, including the exemplary design and implementation illustrated and described herein.

FIG. 1 illustrates the card reader assembly 10 according to the present invention. The card reader assembly 10 provides numerous features and advantages as previously discussed above. The card reader assembly 10 may be constructed on a unitary integrated circuit board or may be several modules interconnected using various techniques for connecting electronic components which are well known in the art.

The card reader assembly 10 includes a card reader module 12, a processor 14 and a plurality of security access module 16. The card reader module 12 may be a standard card reader for reading credit or other cards having a magnetic strip including, but not limited to, credit cards, as well as, smart cards such as those cards having an integrated processor, control, or logic functions that are well known in the art. The card module 12 is in communication with the processor 14 which may be a standard microprocessor capable of processing instructions received from and passed to the card module 12.

The processor 14 is in communication with the security access module 16, which as previously discussed, may be provided on a plurality of sockets (not shown) on the card reader assembly 10. The sockets may be open bays or positions on the card reader assembly 10 whereby an EPROM (electronic programmable read-only memory) chip or other silicone-based chip or other device adapted to retain instructions for communicating with the processor may be retained which are well known in the art. The security access modules 16, as previously discussed, may include encrypted instructions such as by well-known and highly secure encryption technologies, for communicating with the smart cards read by the card reader module 12.

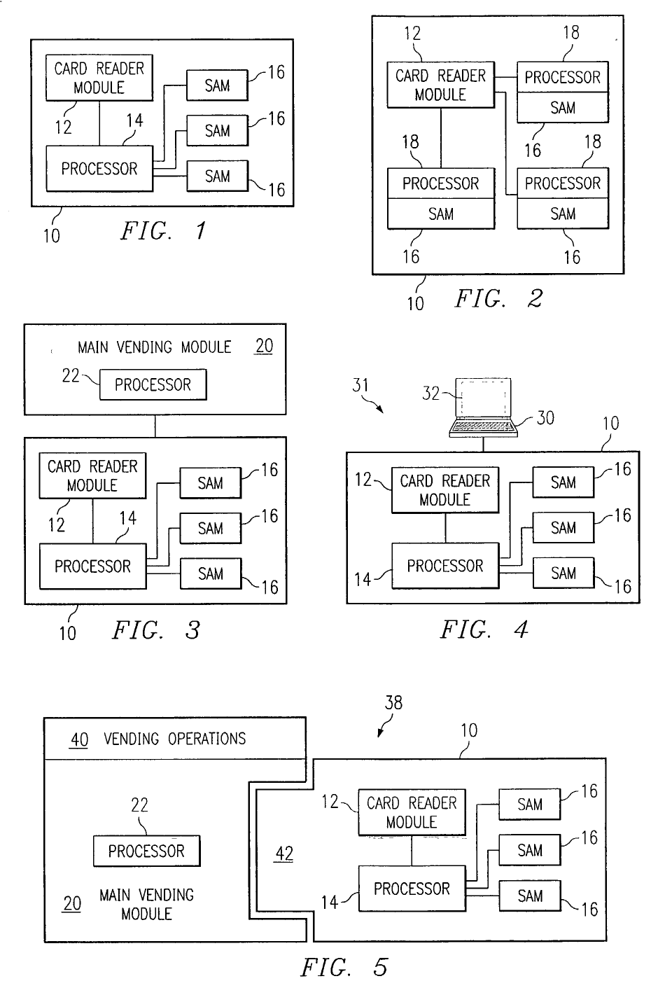

FIG. 2 illustrates another aspect of the card reader assembly 10 with the card reader module 12 for reading smart cards. In this illustration, the security access modules 16 are shown with an integrated processor 18 that is integral to the security access module 16. In this manner, the security access modules 16 are capable of communicating directly with the card reader module 12 and the processor 14 (see FIG. 1) may be eliminated in this instance. It will be appreciated, however, that in certain aspects (not shown) the card reader assembly 10 may be provided with the security access modules 16 having integrated processors 18, and the card reader assembly 10 may also be provided with a processor, such as the processor 14, as well.

The card reader module 12, according to one aspect, may preferably meet ISO standards for quality and rated for a number of insertions. Also, the card reader module 12 may desirably operate with less sophisticated type of smart cards, such as, but not limited to, disposable, reprogrammable, token-based, and electronic purse designs, that do not require separate microprocessors, as well as multiple-application bank smart cards that require microprocessors and one or more security access modules 16. In this aspect, the card reader module 12 may include, not shown, positive contacts for reading card chips, a circuit board with sockets for plug-in microprocessor 14 and multiple sockets for security access modules 16.

FIG. 3 illustrates a block diagram of a main vending module 20 communicating with the card reader assembly 10. The main vending module 20 may be a circuit board or other controls for a vending machine for managing the operational aspects of the vending machine, such as displays and mechanical aspects of the vending machine (not shown). The main vending module 20 may include a processor 22 to control the instructions for operating the vending machine functions.

The card reader assembly 10 communicates with the vending module 20 and manages the financial transactions with respect to use of smart cards. In operation, the card reader module 12 of the card reader assembly 10 detects a card, such as a smart card, and passes the detection information to the processor 14 which determines, based on information obtained from the card reader module 12 about the detected card, which of the security access modules 16 is associated with the smart card detected by the card reader module 12.

It will be appreciated that the smart card and security access modules 16 are integral components having similar security schemes for negotiating financial transactions. Once the processor 14 identifies the appropriate security access modules 16, the security access modules 16, via the processor 14, communicates with the smart card regarding the specific transaction. This information is passed from the card reader assembly 10 to the main vending module 20 for vending purposes.

Information passed between the card reader assembly 10 and main vending module 20 may include displaying charges, for example, on a display portion (not shown) of the vending machine, and balances on the smart card, as well as deductions for purchases made on the vending machine or other information for these purposes. It can be seen that this method of managing many of the security aspects of the financial transaction on the card reader assembly 10 creates a barrier between the main vending module 20 and the card reader assembly 10 which is useful for security reasons, as previously discussed.

FIG. 4 illustrates the card reader assembly 10 coupled to a computer 30 which may be a standard work station or other PC. The connection of the card reader assembly 10 and the computer 30 may be accomplished utilizing an RS232 or USB port or other such connections which are well known in the art. The card reader assembly 10, according to one aspect of the present invention, is utilized as part of a development system 31 whereby the card reader assembly 10 is provided to, for example, developers of the financial institution smart cards systems.

The development system 31 includes an interface 32 which may run on the computer 30, such as a standard computer software application that may be utilized for developing security access modules that are capable of communicating with the security scheme utilized by the financial institution's smart cards. The computer application may have the variety of features and functions including communicating directly with the card reader module 12 and processor 14 for preparing computer instructions which may be subsequently employed as security access modules and placed on the card reader assembly 10 as one or more security access modules 16.

An additional advantage of card reader assembly 10 in that multiple security access module sockets are available so that the vending machine is adapted to accept financial transactions from a variety of different smart card providers.

The development system 31 is further provided with an emulator, which may be software driven or provided by the card reader assembly 10 via the processor 14 or other firmware on the card reader assembly 10, for emulating the vending device for which the security access modules 16 are being developed. One advantage to the development system 31 is that the vending machine provider can easily provide the card reader assembly 10 to the financial institutions without having to provide the financial institution with the complete vending machine to develop the security access modules 16. This provides greater security for the operating system functions managing the vending machine since the proprietary information is not released to third parties.

However, the development system 31 of the present invention provides the flexibility for the financial institution to develop security access modules and guaranty the compatibility of those security access modules once they are employed by the vending machine. Although in one embodiment the card reader assembly 10 may be utilized in the development system 31 for these purposes, it will be appreciated that in other aspects the card reader assembly 10 may be utilized where the connection to the computer 30 may also be employed to connect the card reader assembly 10 to the vending device.

FIG. 5 illustrates another aspect of the present invention of a vending machine 38 including a vending operations portion 40 coupled to the main vending module 20, such as that previously discussed which includes a processor 22. The main vending module 20 communicates with the vending operations portion 40 of the vending machine 38 for managing operational and mechanical aspects of the vending machine 38.

In one aspect of the present invention, the card reader assembly 10 may be coupled by providing a coupling portion 42 of the card reader assembly 10 for communicating with the vending machine 38. This connection may be preferably located near the main vending module 20 for reasons of efficiency.

In this illustration the card reader assembly 10, which as previously discussed, is provided with the plurality of sockets for receiving security access modules 16. The security access modules 16, as previously discussed, are operable for communicating with the security schemes of smart cards provided by various financial institutions and other providers.

In one aspect, the card reader module 12 may communicate with the smart cards either by contact or contact-less methods and via a processor integrated into the security access modules 16, as previously discussed, or via the processor 14, a determination is made as to which one of the sockets includes the security access modules 16 adapted to communicate with the security scheme associated with the card read by the card reader module 12. The card reader assembly 10 then communicates with the vending machine module 20 via the processor 22 to accomplish the vending of the appropriate product or service.

It will be appreciated that one advantage of the present invention is that the security access module 16 may be modular in that they may be removed from the sockets and replaced with other security access modules to allow the vending machine 38 to communicate with other, potentially newer generation, smart cards without the necessity of replacing the main vending module 20 or the card reader assembly 10.

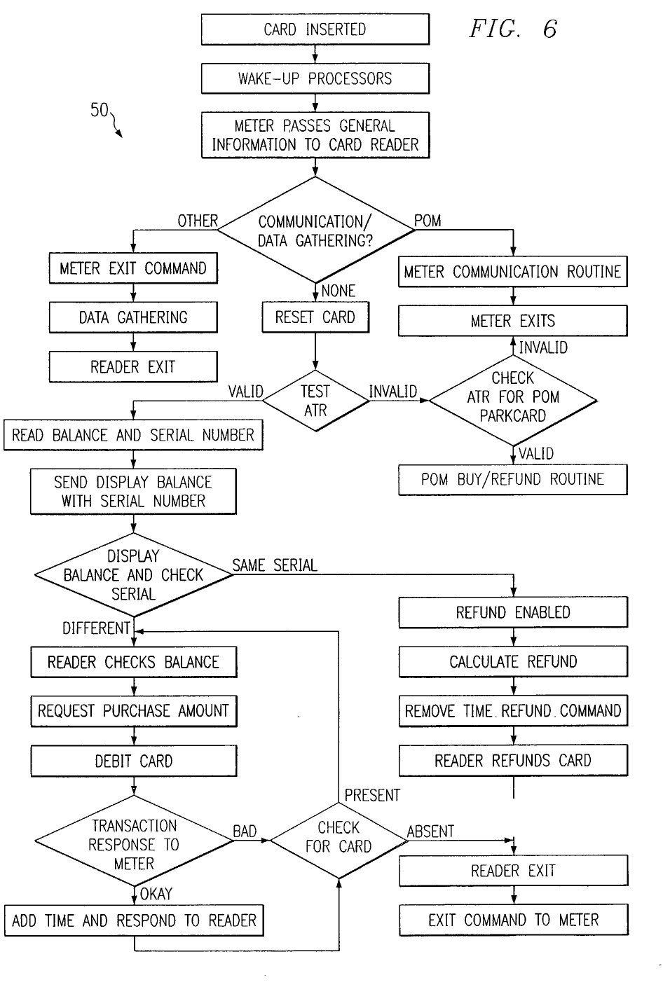

FIG. 6 is a flow chart illustrating, according to one aspect of the present invention, a card insertion routine 50 for detecting the card, such as a smart card, and processing, for example, card balances and refunds. The present illustration may be implemented, for example, using firmware (not shown) provided on the card reader assembly 10. It will be appreciated, however, that the present invention should not be limited to the card insertion routine 50 since other card insertion routines, not shown, may be used as well.

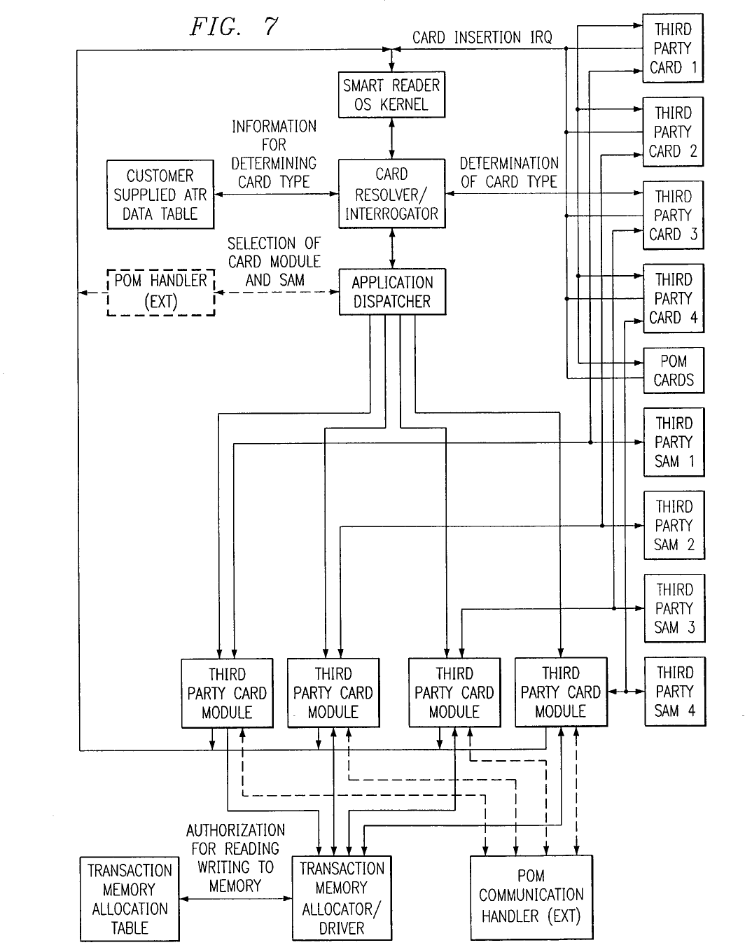

FIG. 7 is a flow chart of another aspect of a development system 31 illustrating the management, implemented as firmware, for example, of third party drivers and security access modules 16 associated with each smart card or other type of cards. After the smart card has been read by the card reader module 12, the development system 31, according to the present aspect, determines the type of smart card, such as by a unique identifier, commonly referred to as ATR, and associates the smart card with the appropriate driver or module to execute and the associated security access module 16. It will be appreciated, however, that the present invention should not be limited to the present aspect of the development system 31 since other development systems may be used as well.

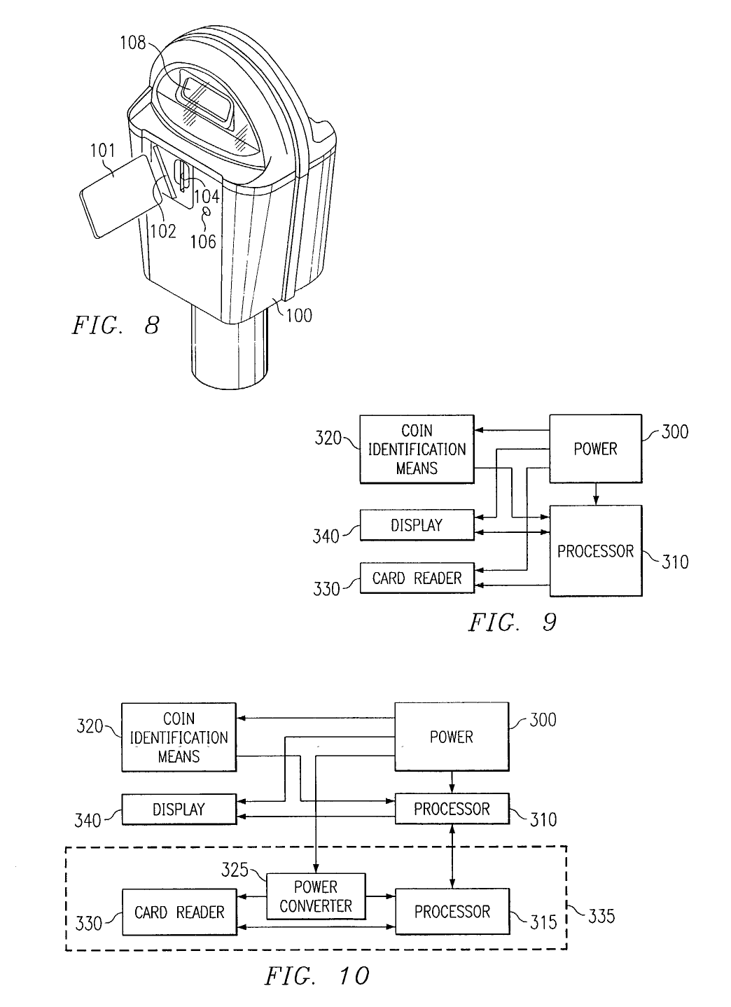

FIG. 8 shows a typical electronic parking meter, having a case 100 to protect the electronics, a display 108, an input slot 104 for coins, and another slot 102 which accepts smart cards 101.

FIG. 9 shows a block diagram of the main circuitry of the parking meter. A power supply 300 powers both the microprocessor 310 and the peripheral devices, the card reader 330, display 340, and the means 320 of identifying coins input to the meter. The means 320 may be any of the various devices and configurations useful for discrimination of coins that are known, such as that disclosed in U.S. Pat. No. 6,026,946 for Enhanced Coin Discrimination Systems and Methods to McCarty, Jr., which is incorporated herein by reference for all purposes.

Because parking meters are stand-alone devices whose power supply 300 is a battery, they are designed to use as little power as possible. For example, although a considerable amount of power is necessary to interface with a user (recognizing the type of payment, interacting with a smart card, determining the validity and denomination of coins, calculating time purchased, and providing a display of the interaction), a meter has long periods of time when is either idle (not in use) or is merely counting down to an expiration time, neither of which involves a user interface. The microprocessor is programmed, according to one aspect of the present invention, to follow some regime in which the meter uses less power when it is not handling an interface with a user.

One power-saving technique requires shutting off the processor 310 and peripherals 320, 330, and 340, until an external signal is received by the meter, e.g., a button on the meter is pressed or a coin or card is inserted. This external signal generates an interrupt, which causes at least a portion of the processor to be powered. The processor 310 can then determine what other parts of the system are needed.

The processor 310 will then activate only those circuits and peripherals needed. Thus, if coins are being input, it is not necessary to activate the card-reading apparatus, and vice versa. It is notable that such architecture is known as interrupt driven.

Alternatively, rather than waiting for an interrupt, the processor 310 may be programmed to be periodically activated in order to check whether an input has been made. For example, the processor 310 may be powered every few hundred milliseconds while it checks for user activity; if none is present, it shuts itself down until time for the next check. This is a polling architecture. However, like the interrupt driven architecture, the processor 310 does not activate other electronic portions of the meter unless they are currently needed, so that the power use is kept low.

It is becoming common for consumers to be able to buy smart cards 101, shaped like a credit card, for use in paying vending devices, such as telephones and parking meters. These smart cards 101 contain an electronic module which is programmed with a certain value. When the consumer inserts the smart card 101 into a device the device and smart card 101 interact, with the cost of the transaction being deducted from the card and added to the value stored in the device. For instance, when a user inserts the smart card 101 into a parking meter to purchase an hour of time, the cost of an hour's parking is deducted from the value of the smart card 101 and stored in the memory of the parking meter. This value will later be electronically retrieved from the meter and credited to the municipality or organization owning the meter. For the owner of the meter, one advantage is that no currency is collected in the meter, reducing the chance of theft.

Meanwhile, the consumer is saved the need to carry coins for the meter, and when the smart card 101 is depleted of value, the smart card 101 can either be replaced or refilled, depending on service arrangements with the smart card 101 provider

Smart card readers are not designed for used in a battery operated device. Rather, they typically are located in or near buildings, where permanent electrical connections are available. When such a reader is placed into a parking meter, care must be taken that the reader does not quickly deplete the meter's battery. According to ones aspect of the present invention, this may be accomplished by placing the card reader 330 under the control of the meter's microprocessor or processor 310, as shown in FIG. 9, where it can be activated only when necessary.

Thus, a microprocessor board, not shown, for the parking meter 100 is generally designed to accept and read smart cards 101, regardless of whether or not the meter it is placed in accepts smart cards 101. As technology changes for smart cards, the microprocessors already in meters must be replaced or reprogrammed to accept these changes, or the whole meter (if it accepts smart cards) becomes obsolete. This is frustrating and costly for parking meter manufacturers and their customers.

Additionally, multiple-application smart cards 101 that are cleared through the banking system are being designed and require one or more Security Access Modules (SAMs) for matching the security codes between the cards and meters and other devices in the system. Providing for these SAM modules on the parking meter circuit board makes the circuit board expensive for those who do not utilize smart cards 101 and makes the boards easily obsolete if technology changes.

Separating the microprocessor and voltage supply for the smart card reader from the main microprocessor and voltage supply which perform the other functions of the meter. The apparatus to read a smart card plugs into the circuit board of a base-model electronic meter, yet has sockets for its own plug-in microprocessor and SAM modules. In at least some embodiments, different voltages can then be implemented for the two sets of electronics. For instance, the main microprocessor can use a low-voltage power supply, while the card reader module contains a voltage step-up to provide the higher voltages necessary only to the card reader.

The present invention, according to one aspect, may provide the advantages that main electronics can be optimized for super-low power consumption regardless of the needs of the card reader module, that upgrading to new versions of smart cards is simplified, and that the base model parking meters that do not accept smart cards would not have costly, unused, features on board.

FIG. 10 illustrates the coin identification module 320 and the display 340 are both still directly powered and controlled by the power supply 300 and main processor 310 respectively. However, the main processor 310 no longer contains the logic necessary to operate the card reader 330. Instead, this logic is contained in a separate processor 315 for the card reader 330. Additionally, a power converter 325, which is on card 335, along with processor 315 and card reader 330. The processor 315 will be under the control of main processor 310, but modifications to smart card 101 processing do not require changes to the main processor 310.

Instead, when a new technology is developed in payment cards, the card 335, containing processor 315, card reader 330 and power converter 325, may be removed and replaced by a new card 335 or board which contains the changes. The costs and annoyances of updating the smart card system is minimized. Municipalities who do not use smart cards are not required to pay for a microprocessor which has unnecessary programming, yet they can update to use smart cards by adding the necessary card 335.

The smart card reader 330 includes positive contacts for reading the card chip and a circuit board to step up the voltage, pass through the commands, and provide a CPU clock. The card reader circuit board includes sockets for its own plug-in microprocessor and multiple SAM modules.

Thus, it is apparent that there has been provided, in accordance with the present invention, a card reader assembly having multiple security access modules that satisfy one or more of the advantages set forth above. Although the preferred embodiment has been described in detail, it should be understood that various changes, substitutions, and alterations can be made herein without departing from the scope of the present invention, even if all of the advantages identified above are not present. For example, the various embodiments shown in the drawings herein illustrate that the present invention may be implemented and embodied in a variety of different ways that still fall within the scope of the present invention.

Also, the techniques, designs, elements, and methods described and illustrated in the preferred embodiment as discrete or separate may be combined or integrated with other techniques, designs, elements, or methods without departing from the scope of the present invention. Other examples of changes, substitutions, and alterations are readily ascertainable by one skilled in the art and could be made without departing from the spirit and scope of the present invention.

What is claimed is:

1. A parking meter, comprising:
a data interface element to provide bi-directional data interface with portable purchasing modules;
a display; and
a programmable logic module connected to control the data interface element and the display, the data interface element modularly connected to the programming logic unit in a non-integrated manner, the programmable logic module coupled to control whether the data interface element is powered.

2. The parking meter of claim 1, wherein the data interface element is a smart card reader and the portable purchasing module is a smart card.

3. The parking meter of claim 1, wherein the programmable logic module is a microprocessor.

4. A parking meter, comprising:
a first circuit board having a main microprocessor coupled to a power supply operable to provide power at a first supply voltage;
a display communicating with the first circuit board;
a coin discriminator communicating with the first circuit board; and
a second circuit board having a microprocessor, a power supply operable to provide power at a second supply voltage and a data interface element to provide bi-directional data interface with portable purchasing modules, the second circuit board modularly coupleable to the first circuit board in a non-integral manner.

5. The parking meter of claim 4, wherein the first circuit board receives the first supply voltage and the second circuit board receives the second supply voltage.

6. The parking meter of claim 5, wherein the first supply voltage is different than the second supply voltage.

7. A parking meter, comprising:
a coin input device;
a first microprocessor operatively connected to detect inputs from the coin input device;
a random-access memory which is connected to be read/write accessible by the first microprocessor;
an output device operatively connected to receive outputs from the first microprocessor;
a power supply connected to provide power to the first microprocessor; and
a second user input device and a second microprocessor operatively connected to detect inputs from the second user input device such that the coin input device communicates with the first microprocessor via a first card and the second user input device communicates with the second microprocessor via a second card.

8. The parking meter of claim 7, wherein the second card is modularly coupleable to the first card.

9. The parking meter of claim 8, wherein the second microprocessor is at least partially controlled by said first microprocessor.

10. A development system couplable to a computer system for developing security schemes for a parking meter to utilize smart cards, the development system comprising:
a circuit board having a coupling for communication with the computer system, the circuit board modularly coupleable to the parking meter;
a smart card reader coupled to the circuit board and adapted to communicate with the computer system via the coupling of the circuit board and operative to read smart cards in a contacting or contact-less manner, the smart cards include a security scheme;
and
at least one security access module adapted to communicate with the security scheme of the smart card such that when the smart card reader reads the smart cards, the processor operably determines which of the at least one security access modules is adapted to communicate with the security scheme of the smart card read by the smart card reader.

11. The development system of claim 10, further comprising a plurality of security access modules.

12. The development system of claim 11, further comprising a processor in communication with the reader.

13. The development system of claim 11, further comprising a processor integral to the at least one security access module.

14. The development system of claim 11, further comprising a plurality processors, each one of the plurality of processors dedicated to one of the at least one security access modules.

15. The development system of claim 11, further comprising a processor in communication with the smart card reader and the at least one security access module.

16. The development system of claim 10, further comprising a development tool operable for producing security access modules compatible with a parking meters, the development tool including an emulator operable to emulate the parking meter for testing the security access module for compatibility with the parking meter.

17. A smart card reader assembly coupleable to a parking meter for allowing smart card transactions, the smart card reader assembly comprising:
a circuit board connectable to the parking meter for communication with the parking meter;
a smart card reader coupled to the circuit board and operative to read smart cards in a contacting or contact-less manner, the smart cards including a security scheme;
at least one socket communicating with the smart card reader and operable to receive a security access module having a processor adapted to communicate with the security scheme of the smart cards, the at least one socket in communication with the processor such that when security access module is received by the socket and the smart card reader reads the smart cards, the processor is operative to determine which of the at least one sockets includes the security access module adapted to communicate with the security scheme of the card read by the smart card reader.

18. The smart card reader assembly of claim 17, further comprising a plurality of sockets operable to receive a plurality of security access modules.

19. A vending machine operable for smart card transactions, the vending machine comprising:
a vending portion operable to vend goods or services;
a main module having a processor and in communication with the vending portion;
a power supply for supplying power to at least the main module; and
a card reader assembly modularly connectable to the main module in a communicating manner, the card reader assembly comprising:
a reader operative to read smart cards in a contacting or contact-less manner, the cards including a security scheme,
a processor in communication with the reader,
at least one security access module adapted to communicate with the security scheme of the cards and in communication with the processor such that when the reader reads the cards, the processor is operative to determine which of the at least one security access module is adapted to communicate with the security scheme of the card.

20. The vending machine of claim 19, wherein the main module is operable to control the supply of power from the power supply to the card reader assembly.

21. The vending machine of claim 19, wherein the power supply is a battery.

22. The vending machine of claim 21, wherein the vending machine is further defined as a parking meter.

23. The vending machine of claim 20, wherein the main module is further provided with a processor and wherein the processor on the main module communicates with the processor on the card reader assembly.

24. The vending machine of claim 23 wherein the processor on the main module is programmed to monitor interrupts to determine when to supply power the card reader assembly.

25. The vending machine of claim 23, wherein the processor on the card reader assembly is programmed to monitor interrupts to determine when to supply power to the reader.

26. The vending machine of claim 23, wherein the card reader assembly is provided with an interrupt operative to wake the processor on the card reader assembly when the smart card is inserted in the reader.

27. The vending machine of claim 23, wherein the processor on the main module is programmed to employ a first power mode when the smart card is inserted in the reader and further programmed to employ a second power mode upon completion of a vending transaction.

28. The vending machine of claim 23, wherein the processor of the main module is programmed for a power conservation mode to substantially reduce the power supplied to the vending machine upon completion of a vending transaction.

29. The vending machine of claim 21, wherein the card reader assembly is further provided with a plurality of sockets adapted to receive a plurality of security access modules, each of the plurality of security access modules corresponding to a security scheme utilized by different smart cards.
